(19) United States
(12) Patent Application Publication
(10) Pub. No.: US 2009/0130296 A1
(43) Pub. Date: May 21, 2009

(54) Fabrication of Organic Electronic Devices by Ink-Jet Printing at Low Temperatures

(75) Inventors: Raymond Kwong, Plainsboro, NJ (US); Chuanjun Xia, Lawrenceville, NJ (US)

Correspondence Address: KENYON & KENYON LLP, 1500 K STREET N.W., SUITE 700, WASHINGTON, DC, 20005, US

(73) Assignee: UNIVERSAL DISPLAY CORPORATION, Ewing, NJ (US)

(21) Appl. No.: 11/940,824

(22) Filed: Nov. 15, 2007

(51) Int. Cl. B05D 5/06; B05D 5/12

(52) U.S. Cl. 427/64; 427/58

(57) ABSTRACT

Methods of forming an organic layer by ink-jet printing in the fabrication of an organic electronic device. The organic layer is formed by ink-jet printing onto a surface, a solution comprising an organic material in a low boiling point solvent. The ink-jet printing occurs at an ambient temperature of less than 20° C. such that the solvent has a vapor pressure of 10 mmHg or less. The ink-jet printing may be performed in a temperature-controlled chamber. After ink-jet printing the solution, the solvent is evaporated such that the organic material remains on the surface, thereby forming the organic layer.

### FIELD OF THE INVENTION

The present invention relates to methods of fabricating organic light-emitting devices.

### BACKGROUND

Opto-electronic devices that make use of organic materials are becoming increasingly desirable for a number of reasons. Many of the materials used to make such devices are relatively inexpensive, so organic opto-electronic devices have the potential for cost advantages over inorganic devices. In addition, the inherent properties of organic materials, such as their flexibility, may make them well suited for particular applications such as fabrication on a flexible substrate. Examples of organic opto-electronic devices include organic light emitting devices (OLEDs), organic phototransistors, organic photovoltaic cells, and organic photodetectors. For OLEDs, the organic materials may have performance advantages over conventional materials. For example, the wavelength at which an organic emissive layer emits light may generally be readily tuned with appropriate dopants.

As used herein, the term “organic” includes polymeric materials as well as small molecule organic materials that may be used to fabricate organic opto-electronic devices. “Small molecule” refers to any organic material that is not a polymer, and “small molecules” may actually be quite large. Small molecules may include repeat units in some circumstances. For example, using a long chain alkyl group as a substituent does not remove a molecule from the “small molecule” class. Small molecules may also be incorporated into polymers, for example as a pendent group on a polymer backbone or as a part of the backbone. Small molecules may also serve as the core moiety of a dendrimer, which consists of a series of chemical shells built on the core moiety. The core moiety of a dendrimer may be a fluorescent or phosphorescent small molecule emitter. A dendrimer may be a “small molecule,” and it is believed that all dendrimers currently used in the field of OLEDs are small molecules. In general, a small molecule has a well-defined chemical formula with a single molecular weight, whereas a polymer has a chemical formula and a molecular weight that may vary from molecule to molecule. As used herein, “organic” includes metal complexes of hydrocarbyl and heteroatom-substituted hydrocarbyl ligands.

OLEDs make use of thin organic films that emit light when voltage is applied across the device. OLEDs are becoming an increasingly interesting technology for use in applications such as flat panel displays, illumination, and backlighting. Several OLED materials and configurations are described in U.S. Pat. Nos. 5,844,363, 6,303,238, and 5,707,745, which are incorporated herein by reference in their entirety.

OLED devices are generally (but not always) intended to emit light through at least one of the electrodes, and one or more transparent electrodes may be useful in an organic opto-electronic devices. For example, a transparent electrode material, such as indium tin oxide (ITO), may be used as the bottom electrode. A transparent top electrode, such as disclosed in U.S. Pat. Nos. 5,703,436 and 5,707,745, which are incorporated by reference in their entireties, may also be used. For a device intended to emit light only through the bottom electrode, the top electrode does not need to be transparent, and may be comprised of a thick and reflective metal layer having a high electrical conductivity. Similarly, for a device intended to emit light only through the top electrode, the bottom electrode may be opaque and/or reflective. Where an electrode does not need to be transparent, using a thicker layer may provide better conductivity, and using a reflective electrode may increase the amount of light emitted through the other electrode, by reflecting light back towards the transparent electrode. Fully transparent devices may also be fabricated, where both electrodes are transparent. Side emitting OLEDs may also be fabricated, and one or both electrodes may be opaque or reflective in such devices.

As used herein, “top” means furthest away from the substrate, while “bottom” means closest to the substrate. For example, for a device having two electrodes, the bottom electrode is the electrode closest to the substrate, and is generally the first electrode fabricated. The bottom electrode has two surfaces, a bottom surface closest to the substrate, and a top surface further away from the substrate. Where a first layer is described as “disposed over” a second layer, the first layer is disposed further away from substrate. There may be other layers between the first and second layer, unless it is specified that the first layer is “in physical contact with” the second layer. For example, a cathode may be described as “disposed over” an anode, even though there are various organic layers in between.

As used herein, “solution processible” means capable of being dissolved, dispersed, or transported in and/or deposited from a liquid medium, either in solution or suspension form.

As used herein, and as would be generally understood by one skilled in the art, a first “Highest Occupied Molecular Orbital” (HOMO) or “Lowest Unoccupied Molecular Orbital” (LUMO) energy level is “greater than” or “higher than” a second HOMO or LUMO energy level if the first energy level is closer to the vacuum energy level. Since ionization potentials (IP) are measured as a negative energy relative to a vacuum level, a higher HOMO energy level corresponds to an IP having a smaller absolute value (an IP that is less negative). Similarly, a higher LUMO energy level corresponds to an electron affinity (EA) having a smaller absolute value (an EA that is less negative). On a conventional energy level diagram, with the vacuum level at the top, the LUMO energy level of a material is higher than the HOMO energy level of the same material. A “higher” HOMO or LUMO energy level appears closer to the top of such a diagram than a “lower” HOMO or LUMO energy level.

### SUMMARY

In one aspect, the present invention provides a method of fabricating an organic electronic device, comprising: providing an electrode disposed over a substrate; and forming a first organic layer on a surface over the electrode by: (a) ink-jet printing a first solution comprising a first organic material in a first solvent onto the surface; and (b) evaporating the first solvent such that the first organic material remains on the surface; wherein the first solvent is a solvent having a vapor pressure of 100 mmHg or greater at 100° C., and wherein the ink-jet printing of the first solution occurs at a first temperature of less than 20° C., and wherein the vapor pressure of the first solvent is 10 mmHg or less at said first temperature.

### BRIEF DESCRIPTION OF THE DRAWINGS

FIG. 1 shows an organic light emitting device having separate electron transport, hole transport, and emissive layers, as well as other layers.

FIG. 2 shows an inverted organic light emitting device that does not have a separate electron transport layer.

FIG. 3 shows a plot of vapor pressure vs. temperature for various organic solvents.

### DETAILED DESCRIPTION

Generally, an OLED comprises at least one organic layer disposed between and electrically connected to an anode and a cathode. When a current is applied, the anode injects holes and the cathode injects electrons into the organic layer(s). The injected holes and electrons each migrate toward the oppositely charged electrode. When an electron and hole localize on the same molecule, an “exciton,” which is a localized electron-hole pair having an excited energy state, is formed. Light is emitted when the exciton relaxes via a photoemissive mechanism. In some cases, the exciton may be localized on an excimer or an exciplex. Non-radiative mechanisms, such as thermal relaxation, may also occur, but are generally considered undesirable.

The initial OLEDs used emissive molecules that emitted light from their singlet states (“fluorescence”) as disclosed, for example, in U.S. Pat. No. 4,769,292, which is incorporated by reference in its entirety. Fluorescent emission generally occurs in a time frame of less than 10 nanoseconds.

More recently, OLEDs having emissive materials that emit light from triplet states (“phosphorescence”) have been demonstrated. Baldo et al., “Highly Efficient Phosphorescent Emission from Organic Electroluminescent Devices,” Nature, vol. 395, 151-154, 1998; (“Baldo-I”) and Baldo et al., “Very high-efficiency green organic light-emitting devices based on electrophosphorescence,” Appl. Phys. Lett., vol. 75, No. 1, 4-6 (1999) (“Baldo-II”), which are incorporated by reference in their entireties. Phosphorescence may be referred to as a “forbidden” transition because the transition requires a change in spin states, and quantum mechanics indicates that such a transition is not favored. As a result, phosphorescence generally occurs in a time frame exceeding at least 10 nanoseconds, and typically greater than 100 nanoseconds. If the natural radiative lifetime of phosphorescence is too long, triplets may decay by a non-radiative mechanism, such that no light is emitted. Organic phosphorescence is also often observed in molecules containing heteroatoms with unshared pairs of electrons at very low temperatures. 2,2′-bipyridine is such a molecule. Non-radiative decay mechanisms are typically temperature dependent, such that an organic material that exhibits phosphorescence at liquid nitrogen temperatures typically does not exhibit phosphorescence at room temperature. But, as demonstrated by Baldo, this problem may be addressed by selecting phosphorescent compounds that do phosphoresce at room temperature. Representative emissive layers include doped or un-doped phosphorescent organometallic materials such as disclosed in U.S. Pat. Nos. 6,303,238 and 6,310,360; U.S. Patent Application Publication Nos. 2002-0034656; 2002-0182441; 2003-0072964; and WO-02/074015.

Generally, the excitons in an OLED are believed to be created in a ratio of about 3:1, i.e., approximately 75% triplets and 25% singlets. See, Adachi et al., “Nearly 100% Internal Phosphorescent Efficiency In An Organic Light Emitting Device,” J. Appl. Phys., 90, 5048 (2001), which is incorporated by reference in its entirety. In many cases, singlet excitons may readily transfer their energy to triplet excited states via “intersystem crossing,” whereas triplet excitons may not readily transfer their energy to singlet excited states. As a result, 100% internal quantum efficiency is theoretically possible with phosphorescent OLEDs. In a fluorescent device, the energy of triplet excitons is generally lost to radiationless decay processes that heat-up the device, resulting in much lower internal quantum efficiencies. OLEDs utilizing phosphorescent materials that emit from triplet excited states are disclosed, for example, in U.S. Pat. No. 6,303,238, which is incorporated by reference in its entirety.

Phosphorescence may be preceded by a transition from a triplet excited state to an intermediate non-triplet state from which the emissive decay occurs. For example, organic molecules coordinated to lanthanide elements often phosphoresce from excited states localized on the lanthanide metal. However, such materials do not phosphoresce directly from a triplet excited state but instead emit from an atomic excited state centered on the lanthanide metal ion. The europium diketonate complexes illustrate one group of these types of species.

Phosphorescence from triplets can be enhanced over fluorescence by confining, preferably through bonding, the organic molecule in close proximity to an atom of high atomic number. This phenomenon, called the heavy atom effect, is created by a mechanism known as spin-orbit coupling. Such a phosphorescent transition may be observed from an excited metal-to-ligand charge transfer (MLCT) state of an organometallic molecule such as tris(2-phenylpyridine)iridium(III).

As used herein, the term “triplet energy” refers to an energy corresponding to the highest energy feature discernable in the phosphorescence spectrum of a given material. The highest energy feature is not necessarily the peak having the greatest intensity in the phosphorescence spectrum, and could, for example, be a local maximum of a clear shoulder on the high energy side of such a peak.

The term “organometallic” as used herein is as generally understood by one of ordinary skill in the art and as given, for example, in “Inorganic Chemistry” (2nd Edition) by Gary L. Miessler and Donald A. Tarr, Prentice Hall (1998). Thus, the term organometallic refers to compounds which have an organic group bonded to a metal through a carbon-metal bond. This class does not include per se coordination compounds, which are substances having only donor bonds from heteroatoms, such as metal complexes of amines, halides, pseudohalides (CN, etc.), and the like. In practice organometallic compounds generally comprise, in addition to one or more carbon-metal bonds to an organic species, one or more donor bonds from a heteroatom. The carbon-metal bond to an organic species refers to a direct bond between a metal and a carbon atom of an organic group, such as phenyl, alkyl, alkenyl, etc., but does not refer to a metal bond to an “inorganic carbon,” such as the carbon of CN or CO.

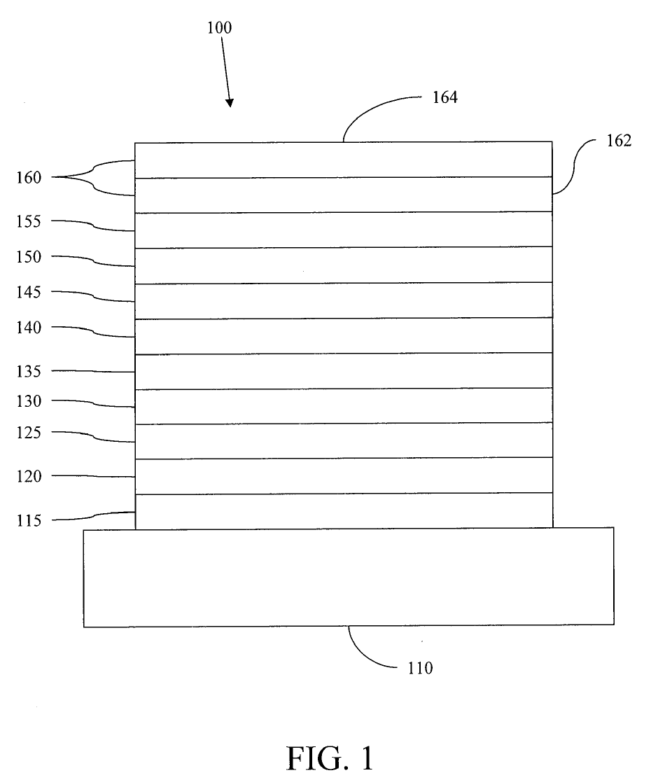

FIG. 1 shows an organic light emitting device 100. The figures are not necessarily drawn to scale. Device 100 may include a substrate 110, an anode 115, a hole injection layer 120, a hole transport layer 125, an electron blocking layer 130, an emissive layer 135, a hole blocking layer 140, an electron transport layer 145, an electron injection layer 150, a protective layer 155, and a cathode 160. Cathode 160 is a compound cathode having a first conductive layer 162 and a second conductive layer 164. Device 100 may be fabricated by depositing the layers described, in order.

Substrate 110 may be any suitable substrate that provides desired structural properties. Substrate 110 may be flexible or rigid. Substrate 110 may be transparent, translucent or opaque. Plastic and glass are examples of preferred rigid substrate materials. Plastic and metal foils are examples of preferred flexible substrate materials. Substrate 110 may be a semiconductor material in order to facilitate the fabrication of circuitry. For example, substrate 110 may be a silicon wafer upon which circuits are fabricated, capable of controlling OLEDs subsequently deposited on the substrate. Other substrates may be used. The material and thickness of substrate 110 may be chosen to obtain desired structural and optical properties.

Anode 115 may be any suitable anode that is sufficiently conductive to transport holes to the organic layers. The material of anode 115 preferably has a work function higher than about 4 eV (a “high work function material”). Preferred anode materials include conductive metal oxides, such as indium tin oxide (ITO) and indium zinc oxide (IZO), aluminum zinc oxide (AlZnO), and metals. Anode 115 (and substrate 110) may be sufficiently transparent to create a bottom-emitting device. A preferred transparent substrate and anode combination is commercially available ITO (anode) deposited on glass or plastic (substrate). A flexible and transparent substrate-anode combination is disclosed in U.S. Pat. Nos. 5,844,363 and 6,602,540 B2, which are incorporated by reference in their entireties. Anode 115 may be opaque and/or reflective. A reflective anode 115 may be preferred for some top-emitting devices, to increase the amount of light emitted from the top of the device. The material and thickness of anode 115 may be chosen to obtain desired conductive and optical properties. Where anode 115 is transparent, there may be a range of thickness for a particular material that is thick enough to provide the desired conductivity, yet thin enough to provide the desired degree of transparency. Other anode materials and structures may be used.

Hole transport layer 125 may include a material capable of transporting holes. Hole transport layer 130 may be intrinsic (undoped), or doped. Doping may be used to enhance conductivity. α-NPD and TPD are examples of intrinsic hole transport layers. An example of a p-doped hole transport layer is m-MTDATA doped with F₄-TCNQ at a molar ratio of 50:1, as disclosed in United States Patent Application Publication No. 2003-0230980 to Forrest et al., which is incorporated by reference in its entirety. Other hole transport layers may be used.

Emissive layer 135 may include an organic material capable of emitting light when a current is passed between anode 115 and cathode 160. Preferably, emissive layer 135 contains a phosphorescent emissive material, although fluorescent emissive materials may also be used. Phosphorescent materials are preferred because of the higher luminescent efficiencies associated with such materials. Emissive layer 135 may also comprise a host material capable of transporting electrons and/or holes, doped with an emissive material that may trap electrons, holes, and/or excitons, such that excitons relax from the emissive material via a photoemissive mechanism. Emissive layer 135 may comprise a single material that combines transport and emissive properties. Whether the emissive material is a dopant or a major constituent, emissive layer 135 may comprise other materials, such as dopants that tune the emission of the emissive material. Emissive layer 135 may include a plurality of emissive materials capable of, in combination, emitting a desired spectrum of light. Examples of phosphorescent emissive materials include Ir(ppy)₃. Examples of fluorescent emissive materials include DCM and DMQA. Examples of host materials include Alq₃, CBP and mCP. Examples of emissive and host materials are disclosed in U.S. Pat. No. 6,303,238 to Thompson et al., which is incorporated by reference in its entirety. Emissive material may be included in emissive layer 135 in a number of ways. For example, an emissive small molecule may be incorporated into a polymer. This may be accomplished by several ways: by doping the small molecule into the polymer either as a separate and distinct molecular species; or by incorporating the small molecule into the backbone of the polymer, so as to form a co-polymer; or by bonding the small molecule as a pendant group on the polymer. Other emissive layer materials and structures may be used. For example, a small molecule emissive material may be present as the core of a dendrimer.

Many useful emissive materials include one or more ligands bound to a metal center. A ligand may be referred to as “photoactive” if it contributes directly to the photoactive properties of an organometallic emissive material. A “photoactive” ligand may provide, in conjunction with a metal, the energy levels from which and to which an electron moves when a photon is emitted. Other ligands may be referred to as “ancillary.” Ancillary ligands may modify the photoactive properties of the molecule, for example by shifting the energy levels of a photoactive ligand, but ancillary ligands do not directly provide the energy levels involved in light emission. A ligand that is photoactive in one molecule may be ancillary in another. These definitions of photoactive and ancillary are intended as non-limiting theories.

Electron transport layer 145 may include a material capable of transporting electrons. Electron transport layer 145 may be intrinsic (undoped), or doped. Doping may be used to enhance conductivity. Alq₃ is an example of an intrinsic electron transport layer. An example of an n-doped electron transport layer is BPhen doped with Li at a molar ratio of 1:1, as disclosed in United States Patent Application Publication No. 2003-02309890 to Forrest et al., which is incorporated by reference in its entirety. Other electron transport layers may be used.

The charge carrying component of the electron transport layer may be selected such that electrons can be efficiently injected from the cathode into the LUMO (Lowest Unoccupied Molecular Orbital) energy level of the electron transport layer. The “charge carrying component” is the material responsible for the LUMO energy level that actually transports electrons. This component may be the base material, or it may be a dopant. The LUMO energy level of an organic material may be generally characterized by the electron affinity of that material and the relative electron injection efficiency of a cathode may be generally characterized in terms of the work function of the cathode material. This means that the preferred properties of an electron transport layer and the adjacent cathode may be specified in terms of the electron affinity of the charge carrying component of the ETL and the work function of the cathode material. In particular, so as to achieve high electron injection efficiency, the work function of the cathode material is preferably not greater than the electron affinity of the charge carrying component of the electron transport layer by more than about 0.75 eV, more preferably, by not more than about 0.5 eV. Similar considerations apply to any layer into which electrons are being injected.

Cathode 160 may be any suitable material or combination of materials known to the art, such that cathode 160 is capable of conducting electrons and injecting them into the organic layers of device 100. Cathode 160 may be transparent or opaque, and may be reflective. Metals and metal oxides are examples of suitable cathode materials. Cathode 160 may be a single layer, or may have a compound structure. FIG. 1 shows a compound cathode 160 having a thin metal layer 162 and a thicker conductive metal oxide layer 164. In a compound cathode, preferred materials for the thicker layer 164 include ITO, IZO, and other materials known to the art. U.S. Pat. Nos. 5,703,436, 5,707,745, 6,548,956 B2 and 6,576,134 B2, which are incorporated by reference in their entireties, disclose examples of cathodes including compound cathodes having a thin layer of metal such as Mg:Ag with an overlying transparent, electrically-conductive, sputter-deposited ITO layer. The part of cathode 160 that is in contact with the underlying organic layer, whether it is a single layer cathode 160, the thin metal layer 162 of a compound cathode, or some other part, is preferably made of a material having a work function lower than about 4 eV (a “low work function material”). Other cathode materials and structures may be used.

Blocking layers may be used to reduce the number of charge carriers (electrons or holes) and/or excitons that leave the emissive layer. An electron blocking layer 130 may be disposed between emissive layer 135 and the hole transport layer 125, to block electrons from leaving emissive layer 135 in the direction of hole transport layer 125. Similarly, a hole blocking layer 140 may be disposed between emissive layer 135 and electron transport layer 145, to block holes from leaving emissive layer 135 in the direction of electron transport layer 145. Blocking layers may also be used to block excitons from diffusing out of the emissive layer. The theory and use of blocking layers is described in more detail in U.S. Pat. No. 6,097,147 and United States Patent Application Publication No. 2003-02309890 to Forrest et al., which are incorporated by reference in their entireties.

Generally, injection layers are comprised of a material that may improve the injection of charge carriers from one layer, such as an electrode or an organic layer, into an adjacent organic layer. Injection layers may also perform a charge transport function. In device 100, hole injection layer 120 may be any layer that improves the injection of holes from anode 115 into hole transport layer 125. CuPc is an example of a material that may be used as a hole injection layer from an ITO anode 115, and other anodes. In device 100, electron injection layer 150 may be any layer that improves the injection of electrons into electron transport layer 145. LiF/Al is an example of a material that may be used as an electron injection layer into an electron transport layer from an adjacent layer. Other materials or combinations of materials may be used for injection layers. Depending upon the configuration of a particular device, injection layers may be disposed at locations different than those shown in device 100. More examples of injection layers are provided in U.S. patent application Ser. No. 09/931,948 to Lu et al., which is incorporated by reference in its entirety. A hole injection layer may comprise a solution deposited material, such as a spin-coated polymer, e.g., PEDOT:PSS, or it may be a vapor deposited small molecule material, e.g., CuPc or MTDATA.

A hole injection layer (HIL) may planarize or wet the anode surface so as to provide efficient hole injection from the anode into the hole injecting material. A hole injection layer may also have a charge carrying component having HOMO (Highest Occupied Molecular Orbital) energy levels that favorably match up, as defined by their herein-described relative ionization potential (IP) energies, with the adjacent anode layer on one side of the HIL and the hole transporting layer on the opposite side of the HIL. The “charge carrying component” is the material responsible for the HOMO energy level that actually transports holes. This component may be the base material of the HIL, or it may be a dopant. Using a doped HIL allows the dopant to be selected for its electrical properties, and the host to be selected for morphological properties such as wetting, flexibility, toughness, etc. Preferred properties for the HIL material are such that holes can be efficiently injected from the anode into the HIL material. In particular, the charge carrying component of the HIL preferably has an IP not more than about 0.7 eV greater that the IP of the anode material. More preferably, the charge carrying component has an IP not more than about 0.5 eV greater than the anode material. Similar considerations apply to any layer into which holes are being injected. HIL materials are further distinguished from conventional hole transporting materials that are typically used in the hole transporting layer of an OLED in that such HIL materials may have a hole conductivity that is substantially less than the hole conductivity of conventional hole transporting materials. The thickness of the HIL of the present invention may be thick enough to help planarize or wet the surface of the anode layer. For example, an HIL thickness of as little as 10 nm may be acceptable for a very smooth anode surface. However, since anode surfaces tend to be very rough, a thickness for the HIL of up to 50 nm may be desired in some cases.

A protective layer may be used to protect underlying layers during subsequent fabrication processes. For example, the processes used to fabricate metal or metal oxide top electrodes may damage organic layers, and a protective layer may be used to reduce or eliminate such damage. In device 100, protective layer 155 may reduce damage to underlying organic layers during the fabrication of cathode 160. Preferably, a protective layer has a high carrier mobility for the type of carrier that it transports (electrons in device 100), such that it does not significantly increase the operating voltage of device 100. CuPc, BCP, and various metal phthalocyanines are examples of materials that may be used in protective layers. Other materials or combinations of materials may be used. The thickness of protective layer 155 is preferably thick enough that there is little or no damage to underlying layers due to fabrication processes that occur after organic protective layer 160 is deposited, yet not so thick as to significantly increase the operating voltage of device 100. Protective layer 155 may be doped to increase its conductivity. For example, a CuPc or BCP protective layer 160 may be doped with Li. A more detailed description of protective layers may be found in U.S. patent application Ser. No. 09/931,948 to Lu et al., which is incorporated by reference in its entirety.

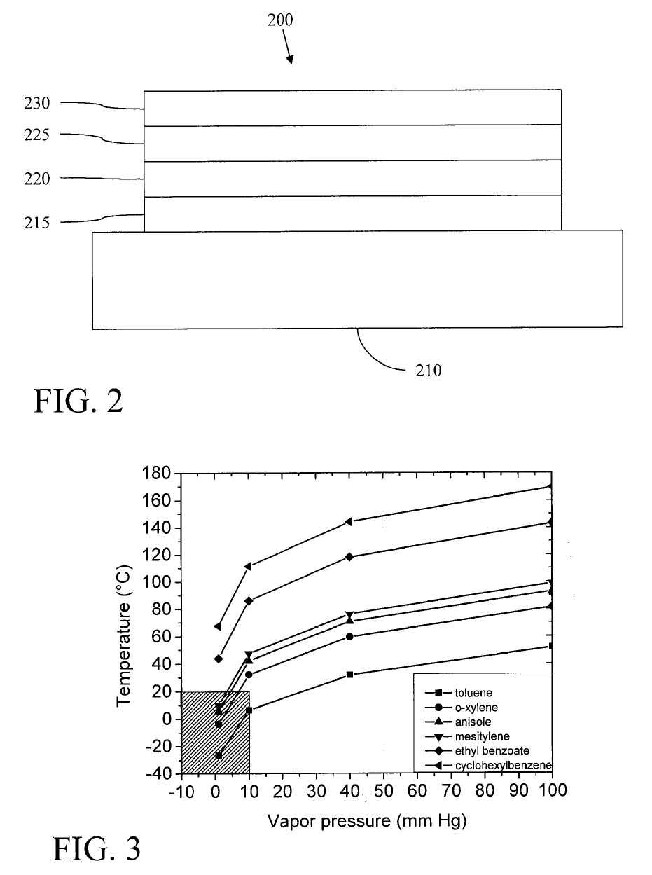

FIG. 2 shows an inverted OLED 200. The device includes a substrate 210, an cathode 215, an emissive layer 220, a hole transport layer 225, and an anode 230. Device 200 may be fabricated by depositing the layers described, in order. Because the most common OLED configuration has a cathode disposed over the anode, and device 200 has cathode 215 disposed under anode 230, device 200 may be referred to as an “inverted” OLED. Materials similar to those described with respect to device 100 may be used in the corresponding layers of device 200. FIG. 2 provides one example of how some layers may be omitted from the structure of device 100.

The simple layered structure illustrated in FIGS. 1 and 2 is provided by way of non-limiting example, and it is understood that embodiments of the invention may be used in connection with a wide variety of other structures. The specific materials and structures described are exemplary in nature, and other materials and structures may be used. Functional OLEDs may be achieved by combining the various layers described in different ways, or layers may be omitted entirely, based on design, performance, and cost factors. Other layers not specifically described may also be included. Materials other than those specifically described may be used. Although many of the examples provided herein describe various layers as comprising a single material, it is understood that combinations of materials, such as a mixture of host and dopant, or more generally a mixture, may be used. Also, the layers may have various sublayers. The names given to the various layers herein are not intended to be strictly limiting. For example, in device 200, hole transport layer 225 transports holes and injects holes into emissive layer 220, and may be described as a hole transport layer or a hole injection layer. In one embodiment, an OLED may be described as having an “organic layer” disposed between a cathode and an anode. This organic layer may comprise a single layer, or may further comprise multiple layers of different organic materials as described, for example, with respect to FIGS. 1 and 2.

Structures and materials not specifically described may also be used, such as OLEDs comprised of polymeric materials (PLEDs) such as disclosed in U.S. Pat. No. 5,247,190, Friend et al., which is incorporated by reference in its entirety. By way of further example, OLEDs having a single organic layer may be used. OLEDs may be stacked, for example as described in U.S. Pat. No. 5,707,745 to Forrest et al, which is incorporated by reference in its entirety. The OLED structure may deviate from the simple layered structure illustrated in FIGS. 1 and 2. For example, the substrate may include an angled reflective surface to improve out-coupling, such as a mesa structure as described in U.S. Pat. No. 6,091,195 to Forrest et al., and/or a pit structure as described in U.S. Pat. No. 5,834,893 to Bulovic et al., which are incorporated by reference in their entireties.

Unless otherwise specified, any of the layers of the various embodiments may be deposited by any suitable method. For the organic layers, preferred methods include thermal evaporation, ink-jet, such as described in U.S. Pat. Nos. 6,013,982 and 6,087,196, which are incorporated by reference in their entireties, organic vapor phase deposition (OVPD), such as described in U.S. Pat. No. 6,337,102 to Forrest et al., which is incorporated by reference in its entirety, and deposition by organic vapor jet printing (OVJP), such as described in U.S. patent application Ser. No. 10/233,470, which is incorporated by reference in its entirety. Other suitable deposition methods include spin coating and other solution based processes. Solution based processes are preferably carried out in nitrogen or an inert atmosphere. For the other layers, preferred methods include thermal evaporation. Preferred patterning methods include deposition through a mask, cold welding such as described in U.S. Pat. Nos. 6,294,398 and 6,468,819, which are incorporated by reference in their entireties, and patterning associated with some of the deposition methods such as ink-jet and OVJP. Other methods may also be used. The materials to be deposited may be modified to make them compatible with a particular deposition method. For example, substituents such as alkyl and aryl groups, branched or unbranched, and preferably containing at least 3 carbons, may be used in small molecules to enhance their ability to undergo solution processing. Substituents having 20 carbons or more may be used, and 3-20 carbons is a preferred range. Materials with asymmetric structures may have better solution processibility than those having symmetric structures, because asymmetric materials may have a lower tendency to recrystallize. Dendrimer substituents may be used to enhance the ability of small molecules to undergo solution processing.

The molecules disclosed herein may be substituted in a number of different ways without departing from the scope of the invention. For example, substituents may be added to a compound having three bidentate ligands, such that after the substituents are added, one or more of the bidentate ligands are linked together to form, for example, a tetradentate or hexadentate ligand. Other such linkages may be formed. It is believed that this type of linking may increase stability relative to a similar compound without linking, due to what is generally understood in the art as a “chelating effect.”

Devices fabricated in accordance with embodiments of the invention may be incorporated into a wide variety of consumer products, including flat panel displays, computer monitors, televisions, billboards, lights for interior or exterior illumination and/or signaling, heads up displays, fully transparent displays, flexible displays, laser printers, telephones, cell phones, personal digital assistants (PDAs), laptop computers, digital cameras, camcorders, viewfinders, micro-displays, vehicles, a large area wall, theater or stadium screen, or a sign. Various control mechanisms may be used to control devices fabricated in accordance with the present invention, including passive matrix and active matrix. Many of the devices are intended for use in a temperature range comfortable to humans, such as 18 degrees C. to 30 degrees C., and more preferably at room temperature (20-25 degrees C.).

The materials and structures described herein may have applications in devices other than OLEDs. For example, other optoelectronic devices such as organic solar cells and organic photodetectors may employ the materials and structures. More generally, organic devices, such as organic transistors, may employ the materials and structures.

Ink-jet printing has been used to directly deposit organic thin film layers in the fabrication of OLEDs. Conventionally, ink-jet printing in the fabrication of OLEDs is performed using solvents with relatively high boiling points because slow evaporation of the solvent helps to achieve good film uniformity as the organic material in the solution is deposited. Also, a slow evaporation rate helps to prevent nozzle clogging, which is commonly caused by drying of the ink-jet solution. However, because residual solvent in the deposited layer can reduce device performance, the solvent should ultimately be removed from the deposited layer. Thus, one of the problems with the use of high boiling point solvents is that the solvent can be difficult to remove from the deposited layer. Baking at high temperatures can accelerate the removal of the solvent, but this can cause heat degradation of the device. Also, even baking at high temperatures may not completely remove the solvent residue from the deposited layer. As explained above, solvent residue can harm device performance (especially device lifetime).

As such, the present invention provides methods for fabricating organic electronic devices without the use of high boiling point solvents. As used herein, a “low boiling point solvent” refers to an organic solvent having a vapor pressure of 100 mmHg or greater at a temperature of 100° C. A high boiling point solvent is an organic solvent that is not a low boiling point solvent. Depending upon the particular application, any of various types of low boiling point solvents are suitable for use in the present invention, including toluene, o-xylene, anisole, mesitylene, or mixtures thereof. A suitable solvent can be chosen on the basis of known vapor pressure vs. temperature relationships (for example, see Table 1 below, which is also plotted in FIG. 3). In addition to its boiling point characteristics, the solvent can be selected on the basis of various other properties, including its surface tension, viscosity, and ability to dissolve organic materials that are used in organic electronic devices.

TABLE 1
Temperature (° C.)

| | | | | | | ethyl | CHB (cyclo- |
|---|---|---|---|---|---|---|---|
| | | toluene | o-xylene | anisole | mesitylene | benzoate | hexylbenze) |
| Vapor Pressure | 1 | −26.7 | −3.8 | 5.4 | 9.6 | 44 | 67.5 |
| | 10 | 6.4 | 32.1 | 42.2 | 47.4 | 86 | 111.3 |
| | 40 | 31.8 | 59.5 | 70.7 | 76.1 | 118.2 | 144 |
| | 100 | 51.9 | 81.3 | 93 | 98.9 | 143.2 | 169.3 |
| | 400 | 89.5 | 121.7 | 133.8 | 141 | 188.4 | 214.6 |
| | 760 | 110.6 | 144.4 | 155.5 | 164.7 | 213.4 | 240 |

The method comprises depositing a solution comprising an organic material in a low boiling point solvent on a surface over a substrate by ink-jet printing. As used herein, “a surface over” a particular structure refers to the surface of the structure itself or any surface that is disposed further away from the structure. For example, “a surface over an electrode” may be the surface of the electrode itself or a surface of another structure (e.g., a hole transport layer) that is disposed further away from the electrode. The organic material may comprise any of various types of organic materials used in organic electronic devices, including organic materials used in the fabrication OLEDs. For example, the organic material may include a hole-transporting material (e.g., for depositing a hole-transporting layer), an emissive material (e.g., for depositing an emissive layer), or a host material. The organic material may contain a small molecule, a polymer, or a precursor which is converted to a polymer by an activation step (e.g., by heat treatment). In some cases, the organic material may contain cross-linkable compounds. The concentration of the organic material in the solution will vary according to the particular application. In certain embodiments, the concentration of the organic material in the solution is in the range of 0.0001% to 50% by weight.

The ink-jet deposition occurs at a temperature of less than 20° C. such that the solvent has a vapor pressure of 10 mmHg or less at that temperature. The deposition temperature may be controlled in various ways, including controlling the ambient temperature (e.g., performing the ink-jet deposition in a temperature-controlled chamber), controlling the solution temperature, controlling the substrate temperature, and/or controlling the inkjet printer head temperature. Because of the low vapor pressure at this relatively lower temperature (compared to some conventional ink-jet printing processes used in OLED fabrication), the solvent is slow to evaporate and remains on the surface long enough to result in an organic layer having good uniformity. In certain embodiments, the deposition is performed at a temperature of less than 20° C.; and in some cases, less than 15° C., and in some cases, less than 10° C., depending upon various factors, including the temperature needed to reduce the vapor pressure of the solvent to 10 mmHg or less. In certain embodiments, the deposition is performed at a temperature in the range of −40° C. to 20° C.; and in some cases, in the range of −20° C. to 20° C. Other deposition conditions (e.g., ambient pressure) will vary according to the particular application. In certain embodiments, the deposition is performed at an ambient pressure of about 1 ATM.

After the deposition of the solution containing the organic material, the solvent is removed by evaporation using any of various techniques, including heat treatment (e.g., by raising the ambient temperature) or reduced pressure (e.g., vacuum). By evaporation of the solvent, at least some of the organic material is left remaining on the surface on which the solution was deposited. In certain embodiments, substantially all of the organic material is left remaining on the surface. In certain embodiments, after deposition of the solution, the ambient temperature is raised to a temperature above 20° C. to accelerate the evaporation of the solvent.

Because a low boiling point solvent is used, the solvent can be evaporated at lower temperatures than that needed to evaporate high boiling point solvents. This reduces the risk of causing heat degradation to the device, while enabling removal of the solvent from the deposited layer. In some cases, the evaporation takes place at a temperature less than 200° C.; and in some case, at a temperature less than 100° C.; and in some cases, at a temperature less than 50° C., depending on various factors, including the type of solvent used and the susceptibility of the device to head degradation.

Thus, using ink-jet printing with a low boiling point solvent at a relatively lower temperature such that the solvent has a vapor pressure of 10 mmHg or less has the synergistic result of allowing the fabrication of organic electronic devices with good film uniformity and reduced risk of device degradation that is otherwise caused by the high temperature treatments that are sometimes used to evaporate high boiling points solvents. Additionally, the methods of the present invention can reduce the problem of nozzle clogging that occurs with the use of low boiling point solvents in ink-jet printing.

In certain embodiments, multiple layers of an organic electronic device may be deposited using the methods of the present invention. For example, in the fabrication of an OLED, a hole transporting layer may be deposited by ink-jet printing a first solution having a first organic material in a first solvent, and an emissive layer may be deposited by ink-jet printing a second solution having a second organic material in a second solvent. In cases where two adjacent layers are formed using the methods of the present invention, the increased viscosity of the solution at low temperatures can reduce the interpenetration between the two adjacent layers (e.g., between a hole-transporting layer and an adjacently positioned emissive layer). This can further synergistically result in improved device performance.

It is understood that the various embodiments described herein are by way of example only, and are not intended to limit the scope of the invention. For example, many of the materials and structures described herein may be substituted with other materials and structures without deviating from the spirit of the invention. It is understood that various theories as to why the invention works are not intended to be limiting. For example, theories relating to charge transfer are not intended to be limiting.

While the present invention is described with respect to particular examples and preferred embodiments, it is understood that the present invention is not limited to these examples and embodiments. The present invention as claimed therefore includes variations from the particular examples and preferred embodiments described herein, as will be apparent to one of skill in the art.

### MATERIAL DEFINITIONS

CBP 4,4′-N,N-dicarbazole-biphenyl
m-MTDATA 4,4′,4″-tris(3-methylphenylphenlyamino)triphenylamine
Alq₃ 8-tris-hydroxyquinoline aluminum
Bphen 4,7-diphenyl-1,10-phenanthroline
n-Bphen n-doped Bphen (doped with lithium)
F₄-TCNQ tetrafluoro-tetracyano-quinodimethane
p-MTDATA p-doped m-MTDATA (doped with F₄-TCNQ)
Ir(ppy)₃ tris(2-phenylpyridine)-iridium
Ir(ppz)₃ tris(1-phenylpyrazoloto,N,C(2′)iridium(III)
BCP 2,9-dimethyl-4,7-diphenyl-1,10-phenanthroline
TAZ 3-phenyl-4-(1′-naphthyl)-5-phenyl-1,2,4-triazole
CuPc copper phthalocyanine
ITO indium tin oxide
NPD N,N′-diphenyl-N—N′-di(1-naphthyl)-benzidine
TPD N,N′-diphenyl-N—N′-di(3-toly)-benzidine
BAlq aluminum(III)bis(2-methyl-8-hydroxyquinolinato)₄-phenylphenolate
mCP 1,3-N,N-dicarbazole-benzene
DCM 4-(dicyanoethylene)-6-(4-dimethylaminostyryl-2-methyl)-4H-pyran
DMOA N,N′-dimethylquinacridone
PEDOT:PSS an aqueous dispersion of poly(3,4-ethylenedioxythiophene) with polystyrenesulfonate (PSS) hfac hexafluoroacetylacetonate
1,5-COD 1,5-cyclooctadiene
VTES vinyltriethylsilane
BTMSA bis(trimethylsilyl)acetylene
Ru(acac)₃ tris(acetylacetonato)ruthenium(III)
C₆₀ Carbon 60 (“Buckminsterfullerene”)

We claim:

1. A method of fabricating an organic electronic device, comprising:
providing an electrode disposed over a substrate; and
forming a first organic layer on a surface over the electrode by:
(a) ink-jet printing a first solution comprising a first organic material in a first solvent onto the surface; and
(b) evaporating the first solvent such that the first organic material remains on the surface;
wherein the first solvent is a solvent having a vapor pressure of 100 mmHg or greater at 100° C., and wherein the ink-jet printing of the first solution occurs at a first temperature of less than 20° C., and wherein the vapor pressure of the first solvent is 10 mmHg or less at said first temperature.

2. The method of claim 1, wherein the ink-jet printing takes place in a chamber in which the ambient temperature is controlled.

3. The method of claim 1, wherein the temperature of an ink-jet printer head used in the ink-jet printing, the substrate, the first solution, the ambient environment, or combinations thereof is controlled.

4. The method of claim 1, wherein the first temperature is in the range of −40° C. to 20° C.

5. The method of claim 1, wherein the evaporation comprises raising the ambient temperature to 20° C. or higher.

6. The method of claim 5, wherein the ambient temperature is raised to 200° C. or less.

7. The method of claim 5, wherein the ambient temperature is raised to 100° C. or less.

8. The method of claim 1, wherein the first organic material comprises a small molecule.

9. The method of claim 1, wherein the first organic material comprises a polymer.

10. The method of claim 1, wherein the first organic material comprises cross-linkable organic molecules.

11. The method of claim 1, wherein the first organic material comprises a hole-transporting material, a phosphorescent emissive material, or a host material.

12. The method of claim 1, wherein the first solvent comprises a solvent selected from the group consisting of: toluene, o-xylene, mesitylene, and anisole.

13. The method of claim 1, further comprising:
forming a second organic layer on a surface over the first organic layer by:
(a) ink-jet printing a second solution comprising a second organic material in a second solvent onto the surface over the first organic layer; and
(b) evaporating the second solvent such that the second organic material remains on the surface over the first organic layer;
wherein the second solvent is a solvent having a vapor pressure of 100 mmHg or greater at 100° C., and wherein the ink-jet printing of the second solution occurs at a second temperature of less than 20° C., and wherein the vapor pressure of the second solvent is 10 mmHg or less at said second temperature.

14. The method of claim 13, wherein the organic electronic device is an organic light-emitting device (OLED).

15. The method of claim 14, wherein the first organic material comprises a hole-transporting material and the second organic material comprises a phosphorescent emissive material or a host material.

16. The method of claim 14, wherein the first organic layer is a hole-transporting layer and the second organic layer is an emissive layer.

17. The method of claim 16, wherein the electronic device further comprises an electron-transport layer disposed over the emissive layer.

18. The method of claim 13, wherein the second organic layer is positioned adjacent the first organic layer.

19. The method of claim 1, wherein the organic electronic device is a field-effect transistor.

20. The method of claim 1, wherein the organic electronic device is a photovoltaic device.
